(19) United States
(12) Patent Application Publication
(10) Pub. No.: US 2025/0166362 A1
(43) Pub. Date: May 22, 2025

(54) LEARNING APPARATUS, LEARNING METHOD AND STORAGE MEDIUM

(71) Applicant: NEC Corporation, Minato-ku, Tokyo (JP)

(72) Inventors: Masashi Usami, Tokyo (JP); Koichi Takahashi, Tokyo (JP)

(73) Assignee: NEC Corporation, Minato-ku, Tokyo (JP)

(21) Appl. No.: 18/843,116

(22) PCT Filed: Mar. 30, 2022
(86) PCT No.: PCT/JP2022/015900

§ 371 Date: Aug. 30, 2024

(51) Int. Cl. G06V 10/778; G06V 10/77; G06V 10/82; G06V 40/16

(52) U.S. Cl. CPC G06V 10/778; G06V 10/82; G06V 40/172; G06V 10/7715; G06V 40/168

(57) ABSTRACT

A learning apparatus learns a classifier model that performs multi-class classification of single-label or multi-labels for images, and includes: a learning unit that performs learning of the classifier model using a feature amount extracted from an image for learning as an input; and a margin giving unit that gives a margin to a loss function used for learning, wherein the margin giving unit fixes a total amount of margin to be given for the single-label or the multi-label, and gives a class margin obtained by asymmetrically distributing the total amount of the margin to each of a plurality of classes of the single-label or the multi-labels.

### TECHNICAL FIELD

The present: invention relates to a learning apparatus, a learning method and a storage medium.

### BACKGROUND ART

Non-Patent Literatures 1 to 6 disclose that a margin is given to a loss function that is used for angular metric learning for classification.

### CITATION LIST

### Non-Patent Literature

Non-Patent Literature 1: Hao Wang et al., “CosFace: Large Margin Cosine Loss for Deep Face Recognition”, CVPR2018
Non-Patent Literature 2: Jiankang Deng et al., “ArcFace: Additive Angular Margin Loss for Deep Face Recognition”, CVPR 2019
Non-Patent Literature 3: Kaidi Cao et al., “Learning Imbalanced Datasets with Label-Distribution-Aware Margin Loss”, NeurIPS2019
Non-Patent Literature 4: Hao Liu et al., “AdaptiveFace: Adaptive Margin and Sampling for Face Recognition”, CVPR2019
Non-Patent Literature 5: Zeju Li et al., “Overfitting of Neural Nets Under Class Imbalance: Analysis and Improvements for Segmentation”, MICCAI2019
Non-Patent Literature 6: Zeju Li et al., “Analyzing Overfitting Under Class Imbalance in Neural Networks for Image Segmentation”, IEEE MI 2021

### SUMMARY OF INVENTION

### Technical Problem

However, with the methods described in Non-Patent Literatures 1 and 2, it is difficult to realize a classifier model excellent in separation performance between classes and fairness in separation between classes when learning of a classifier model is performed using a data set having an uneven number of samples of classes.

In Non-Patent Literatures 3 to 6, a contrivance for improving separation performance between classes is incorporated when learning of a classifier model is performed using a data set having an uneven number of samples of classes. However, there are problems described below.

First, Non-Patent Literatures 3 and 4 mainly assume optimization of single-label and multi-class classification, and it is difficult to determine and adjust a margin term so as to maximize an arbitrary fairness index in the case of multi-labels. That is, since Non-Patent Literatures 3 and 4 assume a single-label problem, the assumption is different from that in the case of multi-labels, and the margin determined by the method does not necessarily maximize a fairness index in the case of multi-labels.

Further, Non-Patent Literatures 5 and 6 mainly assume a segmentation task to classify in foreground and background, and it is difficult to determine and adjust a margin term so as to maximize an arbitrary fairness index in the case of a single-label or multi-label multi-class classification task. That is, since Non-Patent Literatures 5 and 6 make a margin by foreground=m (m is a margin term)/background=0 in a segmentation task, it is difficult to allocate a margin term to maximize a fairness index in the case of multi-classes in the first place, and it is impossible to solve the existing problem only by combining Non-Patent Literatures.

An object of the present invention is to provide a learning apparatus, a learning method, and a storage medium capable of realizing a classifier model excellent in separation performance between classes and fairness in separation between classes, even when learning of the classifier model is performed by using a data set in which the number of samples of single-label or multi-label classes is uneven, while solving the above-mentioned problems.

### Solution to Problem

According to one aspect of the present invention, there is provided a learning apparatus that learns a classifier model that performs multi-class classification of single-label or multi-labels for images, the learning apparatus including: a learning unit that performs learning of the classifier model using a feature amount extracted from an image for learning as an input; and a margin giving unit that gives a margin to a loss function used for learning, wherein the margin giving unit fixes a total amount of margin to be given for the single-label or the multi-label, and gives a class margin obtained by asymmetrically distributing the total amount of the margin to each of a plurality of classes of the single-label or the multi-labels.

According to another aspect of the present invention, there is provided a learning method that learns a classifier model that performs multi-class classification of single-label or multi-labels for images, the learning method including: performing learning of the classifier model using a feature amount extracted from an image for learning as an input; and giving a margin to a loss function used for learning, wherein giving the margin fixes a total amount of margin to be given for the single-label or the multi-label, and gives a class margin obtained by asymmetrically distributing the total amount of the margin to each of a plurality of classes of the single-label or the multi-labels.

According to another aspect of the present invention, there is provided a storage medium storing a program that causes a computer to perform: a learning method that learns a classifier model that performs multi-class classification of single-label or multi-labels for images, the learning method including: performing learning of the classifier model using a feature amount extracted from an image for learning as an input; and giving a margin to a loss function used for learning, wherein giving the margin fixes a total amount of margin to be given for the single-label or the multi-label, and gives a class margin obtained by asymmetrically distributing the total amount of the margin to each of a plurality of classes of the single-label or the multi-labels.

### Advantageous Effects of Invention

According to the present invention, it is possible to realize a classifier model excellent in separation performance between classes and fairness in separation between classes, even when learning of the classifier model is performed by using a data set in which the number of samples of single-label or multi-label classes is uneven.

### BRIEF DESCRIPTION OF DRAWINGS

FIG. 1 is a block diagram illustrating a configuration of an information processing apparatus according to a first example embodiment of the present invention.

FIG. 2 is a schematic diagram illustrating a learning method executed by the information processing apparatus according to the first example embodiment of the present invention.

FIG. 3 is a flowchart illustrating the learning method executed by the information processing apparatus according to the first example embodiment of the present invention.

FIG. 4A is a diagram explaining a margin given to a loss function.

FIG. 4B is a diagram illustrating the margin given to the loss function.

FIG. 5 is a diagram schematically illustrating the asymmetry of a class margin automatically determined in the information processing apparatus according to the first example embodiment of the present invention.

FIG. 6 is a schematic diagram illustrating an estimating method performed by an information processing apparatus according to a second example embodiment of the present invention.

FIG. 7 is a flowchart illustrating the estimating method executed by the information processing apparatus according to the second example embodiment of the present invention.

FIG. 8 is a block diagram illustrating a configuration of an information processing apparatus according to a third example embodiment of the present invention.

### DESCRIPTION OF EMBODIMENTS

### First Example Embodiment

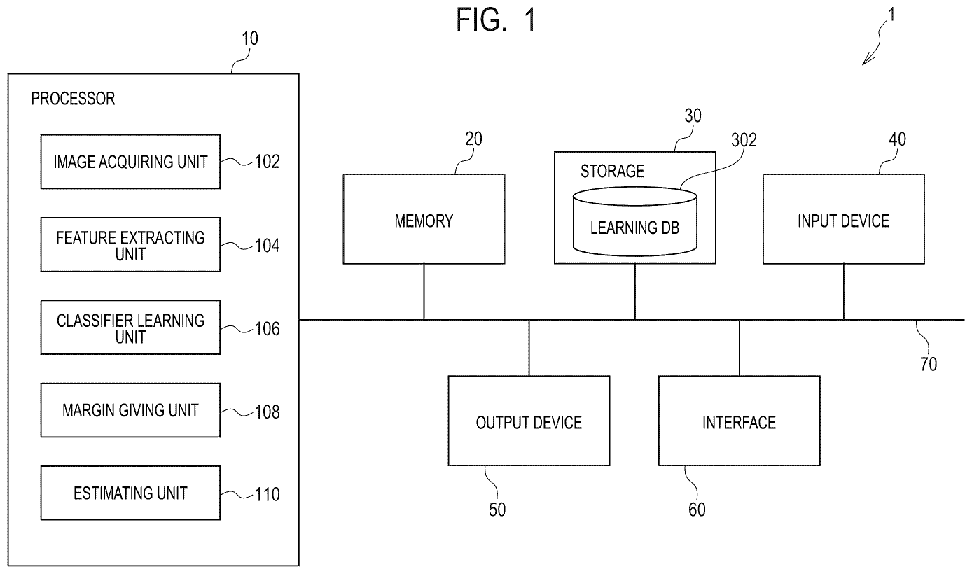

An information processing apparatus and an information processing method according to a first example embodiment of the present invention will be described with reference to FIG. 1 to FIG. 5.

First, the configuration of the information processing apparatus according to the present example embodiment will be described with reference to FIG. 1. FIG. 1 is a block diagram illustrating the configuration of the information processing apparatus 1 according to the present example embodiment. The present example embodiment will describe a case where the information processing apparatus 1 is a learning apparatus that learns a classifier model for performing multi-label multi-class classification of face images by angular metric learning, which is deep metric learning using angles. The classifier model for performing multi-label multi-class classification classifies subject face images into a plurality of classes for each label of a plurality of labels. The number of the labels is not particularly limited as long as it is two or more, and the number of the classes is not particularly limited as long as it is two or more.

As illustrated in FIG. 1, the information processing apparatus 1 according to the present example embodiment includes a processor 10, a memory 20, a storage 30, an input device 40, an output device 50, and an interface 60. The processor 10, the memory 20, the storage 30, the input device 40, the output device 50, and the interface 60 are connected to a common bus 70.

The processor 10 is, for example, a processor such as a CPU (Central Processing Unit) or an MPU (Micro-Processing Unit). The processor 10 operates by executing a program stored in the storage 30 or an external program via the interface 60, and functions as a control unit that controls the operation of the information processing apparatus 1 as a whole. The processor 10 executes a program stored in the storage 30 or an external program via the interface 60 to execute various processes as the information processing apparatus 1.

Specifically, when the information processing apparatus 1 functions as a learning apparatus, the processor 10 executes a program to function as an image acquiring unit 102, a feature extracting unit 104, a classifier learning unit 106, and a margin giving unit 108, as will be described later. Note that the information processing apparatus 1 can also function as an estimating apparatus using a learned classifier model that is learned by functioning as a learning apparatus. In this case, the processor 10 executes a program to function as the image acquiring unit 102, the feature extracting unit 104, and the estimating unit 110, as will be described in a second example embodiment. The information processing apparatus 1 functioning as the learning apparatus and the information processing apparatus 1 functioning as the estimating apparatus may be the same or different from each other. When functioning as the learning apparatus, the processor 10 may not necessarily function as the estimating unit 110. When functioning as the estimating apparatus, the processor 10 may not necessarily function as the classifier learning unit 106 and the margin giving unit 108.

The memory 20 is a main memory device that is configured by a volatile memory such as RAM (Random Access Memory). The memory 20 provides a memory area necessary for the operation of the processor 10, and temporarily stores programs executed by the processor 10, data referred to by the processor 10, and the like.

The storage 30 is an auxiliary storage device configured by, for example, an HDD (Hard Disk Drive), an SSD (Solid State Drive), a ROM (Read Only Memory), and the like. The storage 30 stores programs executed by the processor 10, data referred to by the processor 10, and the like.

The storage 30 stores a learning database (DB, Database) 302 in which a plurality of face images of the number N of samples are stored as face images for learning. The learning DB 302 may be stored in an external device such as a server that is connectable via the interface 60.

The input device 40 is, for example, a keyboard, a mouse, a touch panel, or the like. The input device 40 receives instructions, setting values, or the like from a user. The input device 40 may be a capturing device such as a digital camera. The output device 50 is, for example, a display, a printer, or the like. The output device 50, which is a display, displays various screens such as a setting screen, an execution screen, or the like of a program executed by the processor 10.

The information processing apparatus 1 is connected to an external device such as an external storage device, a peripheral device, a network, or the like via the interface 60. The connection standard of the interface 60 is not particularly limited. The connection method of the interface 60 may be a wired method or a wireless method.

Thus, the information processing apparatus 1 according to the present example embodiment is configured. The information processing apparatus 1 may be a general-purpose computer such as a personal computer, a server, or the like, or may be a computer that is specially designed. Some or all of the functions of the information processing apparatus 1 may be realized by an integrated circuit such as an ASIC (Application Specific Integrated Circuit), an FPGA (Field Programmable Gate Array), or the like.

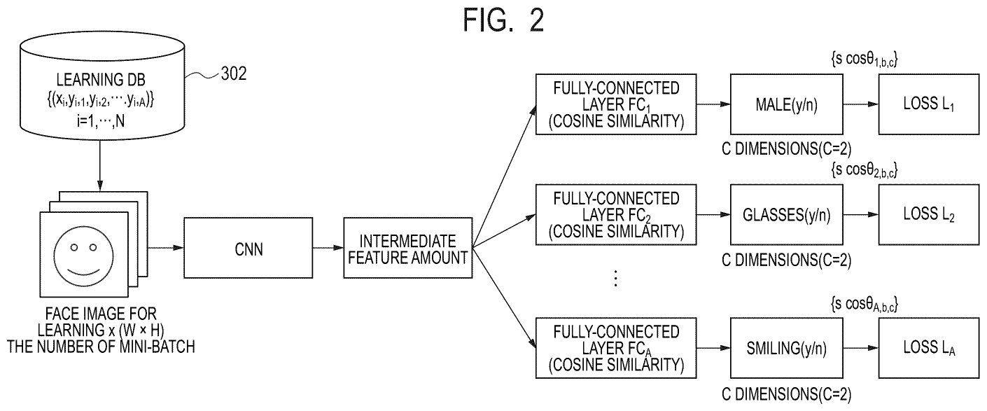

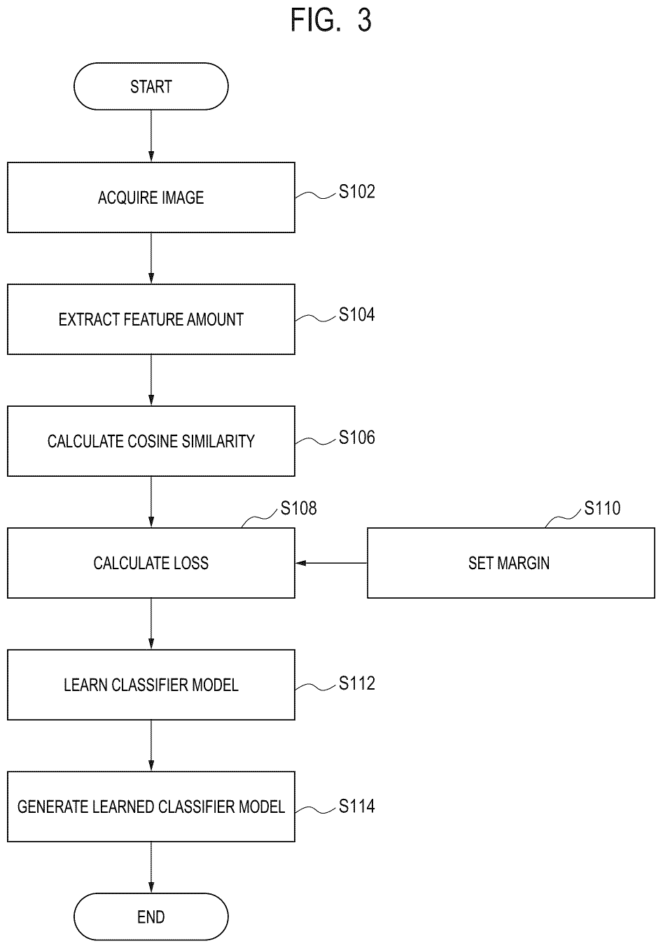

Next, a learning method by the information processing apparatus 1 according to the present example embodiment will be further described with reference to FIG. 2 and FIG. 3. FIG. 2 is a flowchart illustrating the learning method executed by the information processing apparatus 1 according to the present example embodiment. FIG. 3 is a schematic diagram illustrating the learning method executed by the information processing apparatus 1 according to the present example embodiment.

The processor 10 functions as an image acquiring unit 102, a feature extracting unit 104, a classifier learning unit 106, and a margin giving unit 108 by executing a program stored in the storage 30 or an external program via the interface 60. A case of learning a classifier model that performs C class classification of A labels on face images will be described below. Here, A is an integer of 2 or more, and C is an integer of 2 or more. For example, the classifier model is a model that performs multi-label multi-class classification of face images to determine face attributes. Specifically, the classifier model performs, for example, two-class classification of three classes on face images. For example, the classifier model classifies two classes of “male” and “not male” for a label of “male”, two classes of “having glasses” and “not having glasses” for a label of “glasses”, and two classes of “smiling” and “not smiling” for a label of “smiling”. For simplicity, a case is considered in which the number of classes is equal to C for all labels in the following formulas, but C may be different for each label. In this case, C is replaced with Ca, where Ca is an integer of 2 or more that differs for each label a.

As illustrated in FIG. 2 and FIG. 3, the image acquiring unit 102 acquires a mini-batch including a plurality of face images having a batch sample number B from the learning database (DB, Database) 302 in which the plurality of face images having a sample number N are stored as face images for learning (Step 102).

Next, the feature extracting unit 104 extracts a feature amount for each face image included in the mini-batch acquired by the image acquiring unit 102 (Step 104). The feature extracting unit 104 can extract a feature amount from a face image using, for example, a learned convolutional neural network (CNN, Convolutional Neural Network). In this case, the feature extracting unit 104 extracts, as a feature amount of the face image, a D-dimensional feature vector that is an intermediate feature amount output by the intermediate layer of the CNN in response to the input of the face image to the CNN. The feature extracting unit 104 can normalize the intermediate feature amount by L2 normalization. The intermediate layer of the CNN used for extracting the intermediate feature amount is not particularly limited, but is, for example, an intermediate layer of ResNet (See Kaiming He et al., “Deep Residual Learning for Image Recognition”, Proceedings of the IEEE Conference on Computer Vision and Pattern Recognition (CVPR), 2016, pp. 770-778).

Next, the classifier learning unit 106 learns the classifier model by angular metric learning using, as input, the feature vector that is the feature amount of each face image. More specifically, the process is as follows.

First, for each of the labels from the first label to the A-th label, the classifier learning unit 106 calculates cosine similarity between each of the feature vectors of the first to B-th face images and the representative vector of each class (Step 106). The classifier learning unit 106 can calculate the cosine similarity using fully-connected layers FC₁ to FC_{A} corresponding to the respective labels from the first label to the A-th label.

Next, the classifier learning unit 106 uses the calculated cosine similarity to calculate the loss for each of the labels from the first label to the A-th label using a Softmax type loss function (Step 108). The classifier learning unit 106 can calculate the loss Lₐ for the a-th label using a loss function expressed by the following Expression (1-1).

$$[ Math . 1 ]$$

$${L}_{a} = - \frac{1}{B} {\sum }_{b}^{B} log ( \frac{exp ( s ( cos ( {θ}_{a , b , c} ) - {m}_{a , c} ( {γ}_{a} ) ) )}{\begin{matrix}exp ( s ( cos ( {θ}_{a , b , c} ) - {m}_{a , c} ( {γ}_{a} ) ) ) + \\ {\sum }_{{c}^{′} \neq c} exp ( s cos ( {θ}_{a , b , {c}^{′}} ) )\end{matrix}} ) \qquad ( 1 - 1 )$$

In Expression (1-1), θ_{a,b,c} is an angle formed between the feature vector of the b-th face image and the representative vector of the c-th class, which is the correct class, for the a-th label. a is an integer satisfying 1≤a≤A. b is an integer satisfying 1≤b≤B. c is an integer satisfying 1≤c≤C. c′ is an integer satisfying c′≠c and 1≤c′≤C. The three summation symbols indicate, in order from left to right on the right side of Expression (1-1), the sum of b from 1 to B, the sum of c from 1 to C, and the sum of c′ of classes other than c. s is a hyperparameter of angular metric learning, which is set to s=10, for example.

In Expression (1-1), m_{a,c}(γₐ) is a class margin that is a margin determined for the c-th class of the a-th label. m_{a,c}(γₐ) is set by the margin giving unit 108. The margin giving unit 108 sets and gives m_{a,c}(γₐ) to be subtracted from the cosine of the angle θ_{a,b,c} formed by the feature vector extracted from the face image as a feature quantity and the representative vector of the class in the loss function n of Softmax type. In calculating the loss, the margin giving unit 108 sets and gives m_{a,c}(γₐ) calculated by the following Expression (2) to the loss function (Step 110).

$$[ Math . 2 ]$$

$${m}_{a , c} ( {γ}_{a} ) = {α}_{a , c} ( {γ}_{a} ) \times {m}_{a} \qquad ( 2 )$$

In Expression (2), mₐ is a label margin that is a total margin determined for the a-th label. However, mₐ does not necessarily have to be determined for each label, and a common value m can be used for each label. α_{a, c} (γₐ) distributes mₐ according to the number of samples in the c-th class of the a-th label, and is calculated by the following Expression (3). Note that α_{a,c} (γₐ) become 1 when the sum is calculated for c.

$$[ Math . 3 ]$$

$${α}_{a , c} ( {γ}_{a} ) = \frac{exp ( {γ}_{a} {sN}_{a , c} )}{{\sum }_{{c}^{″} ∈ C} exp ( {γ}_{a} {sN}_{a , {c}^{″}} )} \qquad ( 3 )$$

In Expression (3), N_{a,c} represents the proportion of the number of samples of the face images of the c-th class in the a-th label. N_{a,c″} represents the proportion of the number of samples of the face images of the c″-th class (c″ is an integer satisfying 1≤c″≤C) in the a-th label. s is a hyperparameter, which can be the same as s in Expression (1-1). The sum sign of the right-hand denominator in Expression (3) means the sum of all integers satisfying 1≤c″≤C. γₐ is a parameter determined by adjusting the strength of the asymmetry between classes of the class margin. The value of γₐ may be positive or negative, but is a predetermined value that is not —∞ and is less than 0, for example.

In the case of two-class classification of C=2, m_{a,c} (γₐ) calculated by the following Expression (2′) can be set.

$$[ Math . 4 ]$$

$${m}_{a , c} ( {γ}_{a} ) = \frac{{α}_{a , c} ( {γ}_{a} )}{{α}_{a , c} ( {γ}_{a} ) + 1} \times {m}_{a} \qquad ( {2}^{′} )$$

In Expression (2′), α_{a,c} (γₐ) is calculated by the following Expression (3′).

$$[ Math . 5 ]$$

$${α}_{a , c} ( {γ}_{a} ) = {( \frac{{N}_{a , c}}{{N}_{a , {c}^{′}}} )}^{{γ}_{a}} \qquad ( {3}^{′} )$$

Note that, instead of Expression (1-1), the classifier learning unit 106 can also calculate the loss Lₐ for the a-th label by the loss function expressed by the following Expression (1-2) or (1-3). Also in this case, the margin giving unit 108 can set m_{a,c}(γₐ) in the same manner as described above.

$$[ Math . 6 ]$$

$${L}_{a} = - \frac{1}{B} {\sum }_{b}^{B} log ( \frac{exp ( s cos ( {θ}_{a , b , c} + {m}_{a , c} ( {γ}_{a} ) ) )}{\begin{matrix}exp ( s cos ( {θ}_{a , b , c} + {m}_{a , c} ( {γ}_{a} ) ) ) + \\ {\sum }_{{c}^{′} \neq c} exp ( s cos ( {θ}_{a , b , {c}^{′}} ) )\end{matrix}} ) \qquad ( 1 - 2 )$$

$$[ Math . 7 ]$$

$${L}_{a} = - \frac{1}{B} {\sum }_{b}^{B} log ( \frac{exp ( s cos ( {m}_{a , c} ( {γ}_{a} ) {θ}_{a , b , c} ) )}{\begin{matrix}exp ( s cos ( {m}_{a , c} ( {γ}_{a} ) {θ}_{a , b , c} ) ) + \\ {\sum }_{{c}^{′} \neq c} exp ( s cos ( {θ}_{a , b , {c}^{′}} ) )\end{matrix}} ) \qquad ( 1 - 3 )$$

In the case of Expression (1-2), the margin giving unit 108 sets and gives m_{a,c}(γₐ) to be added to the angle θ_{a,b,c} formed by the feature vector extracted as the feature quantity from the face image and the representative vector of the class in the Softmax type loss function. In the case of Expression (1-3), the margin giving unit 108 sets and gives m_{a,c}(γₐ) to be multiplied to the angle θ_{a,b,c} formed by the feature vector extracted as the feature quantity from the face image and the representative vector of the class in the Softmax type loss function.

In addition, instead of Expression (1-1), the classifier learning unit 106 can calculate the loss Lₐ for the a-th label by the loss function expressed by the following Expression (1-4) in which three class margins m₁, m₂, and m₃ are used. Expression (1-4) is a combination of Expression (1-1), Expression (1-2), and Expression (1-3). In this case, the margin giving unit 108 can set each of m₁, m₂, and m₃ in the same manner as the above m_{a, c} (γₐ).

$$[ Math . 8 ]$$

$${L}_{a} = - \frac{1}{B} {\sum }_{b}^{B} log ( \frac{exp ( s ( cos ( {m}_{1} {θ}_{a , b , c} + {m}_{2} ) - {m}_{3} ) )}{\begin{matrix}exp ( s ( cos ( {m}_{1} {θ}_{a , b , c} + {m}_{2} ) - {m}_{3} ) ) + \\ {\sum }_{{c}^{′} \neq c} exp ( s cos ( {θ}_{a , b , {c}^{′}} ) )\end{matrix}} ) \qquad ( 1 - 4 )$$

Next, the classifier learning unit 106 performs learning of the classifier model by updating the parameters of the fully-connected layers so that the loss Lₐ calculated for each label is minimized, and optimizes the parameters of the fully-connected layers FC₁ to FC_{A} (Step 112). For example, the classifier learning unit 106 performs learning of the classifier model so that the loss L of all the A labels calculated by the following Expression (4) is minimized, and optimizes the parameters of the fully-connected layers FC₁ to FC_{A}. The sum symbol on the right side of Expression (4) means the sum of a from 1 to A.

$$[ Math . 9 ]$$

$$L = \frac{1}{A} {\sum }_{a}^{A} {L}_{a} \qquad ( 4 )$$

Note that the processor 10 can repeatedly execute the processes from Step 102 to Step 112 and performs learning of the classifier model by mini-batch learning using a plurality of mini-batches. The processor 10 can also performs learning of the classifier model by batch learning that collectively processes a plurality of face images used for learning, or by online learning that sequentially processes each of a plurality of face images used for learning.

The margin giving unit 108 can set and give the label margin mₐ and the parameter γₐ input from the user via the input device 40 or the like. The user can manually adjust the label margin mₐ and the parameter γₐ to optimize a fairness index such as balanced accuracy, which is an evaluation index of the classifier model. As the fairness index, any index can be used, and F1 score, Matthews correlation coefficient (MCC), or the like can also be used.

The classifier learning unit 106 can also perform learning with the label margin mₐ and the parameter γₐ as learnable parameters instead of manually adjusting the label margin mₐ and the parameter γₐ. Thus, the classifier learning unit 106 can automatically determine the label margin mₐ and the parameter γₐ. Note that the classifier learning unit 106 does not necessarily automatically determine both of the label margin mₐ and the parameter γₐ, but can automatically determine at least one of the label margin mₐ and the parameter γₐ.

When the label margin mₐ and the parameter γₐ are automatically determined, the classifier learning unit 106 can add a constraint condition to the loss function in order to avoid convergence to a trivial solution (see Non-Patent Literature 4). Specifically, the classifier learning unit 106 can add, for example, the constraint condition Lₘ expressed by the following Expression (5) to the loss expressed by Expression (4).

$$[ Math . 10 ]$$

$${L}_{m} = - \frac{λ}{AC} {\sum }_{a}^{A} {m}_{a} \qquad ( 5 )$$

λ is a parameter for adjusting the strength of Lₘ, and the larger the value is set, the larger the label margin mₐ becomes. More strictly, λ can be set for each label, and λ of the a-th label can be incorporated into Expression (5) as λₐ.

Note that it is also possible to set mₐ=m and perform learning with mₐ as a learnable parameter common to all labels. In this case, Lₘ is expressed by the following Expression (5′).

$$[ Math . 11 ]$$

$${L}_{m} = - λ m \qquad ( {5}^{′} )$$

The classifier learning unit 106 learns the classifier model as described above and generates the learned classifier model (Step 114). The classifier learning unit 106 can store the generated classifier model in a storage device such as the storage 30 or an external storage device.

In recent years, the importance of face authentication whose performance does not depend on attributes such as race, gender, or the like, that is, fair face authentication, has been increasing. In order to establish fair authentication, there is a demand for fair classifiers for face attribute estimation in which attributes are estimated from face images. In order to improve the separation performance of a classifier, a margin is given to a loss function in angular metric learning. However, since it is difficult to prepare a data set having a completely uniform number of samples as samples to be used for learning, learning must be performed using an uneven data set including majority samples and minority samples. In such a case, if learning of a classifier is performed using a data set having an uneven number of samples of classes, it is difficult to realize a classifier having excellent separation performance between classes and excellent fairness in separation between classes. In particular, in the case of performing learning of a classifier model that performs multi-label multi-class classification, learning is biased toward simple classes of simple labels, and fair learning may be hindered.

On the other hand, in the present example embodiment, the total amount of margin of each label is fixed as the label margin mₐ, and the label margin mₐ is asymmetrically distributed to the class margins m_{a,c}(γₐ) based on the proportion of samples of the class by the parameter γₐ that determines the strength of asymmetry.

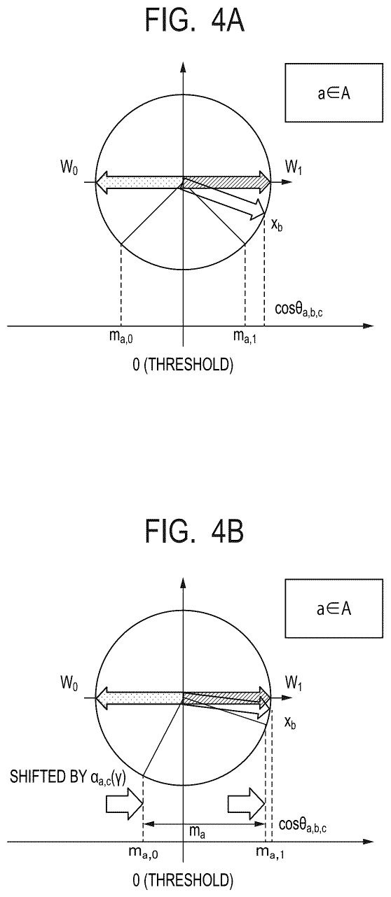

FIG. 4A and FIG. 4B are diagrams visually illustrating the class margins m_{a,0} and m_{a,1} that are set for the classes 0 and 1 of the label a, respectively. FIG. 4A illustrates a case where the same margin is set for each class, and FIG. 4B illustrates a case where the margin is set asymmetrically for each class by the present example embodiment. W₀ and W₁ are representative vectors of the classes 0 and 1, respectively. x_{b} is a feature vector extracted from sample b of a face image. As illustrated in FIG. 4B, in the present example embodiment, the label margin mₐ is fixed, and class margins m_{a,0} and m_{a, 1} in which the label margin mₐ is asymmetrically distributed are set. In FIG. 4B, when class 1 is a minority, a larger class margin is given for class 1 than for class 0, and compact learning within a class is promoted.

Thus, in the present example embodiment, the label margin mₐ is asymmetrically distributed to class margins m_{a,c}(γₐ). As a result, in the present example embodiment, it is possible to learn the classifier model so as to maximize an index related to fairness, such as balanced accuracy, which does not explicitly appear in the loss.

In addition, when the label margin mₐ and the parameter γₐ are automatically determined in the present example embodiment, the component that determines the asymmetry of the class margin is separated from the constraint condition Lₘ, as shown in Expression (5). For this reason, in the present example embodiment, even if the total margin amount of the label reaches the upper limit, the asymmetry of the margin amount of the class inside the label is separately determined, so that learning that does not impair fairness can be realized even in the multi-label format. The method according to the present example embodiment differs from Non-Patent Literature 4 in that the component that determines the asymmetry of the class margin is separated from the constraint condition Lₘ.

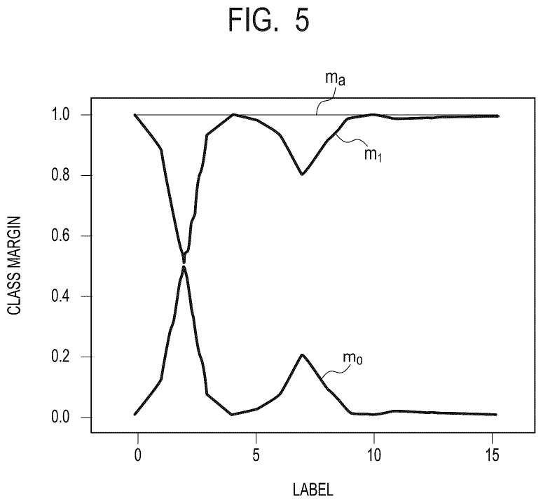

FIG. 5 is a diagram schematically illustrating the asymmetry of class margins automatically determined by the present example embodiment. In FIG. 5, the class margins m₀ and m₁ of two classes 0 and 1 for each label 1 to 15 are illustrated together with the label margin mₐ. As illustrated in FIG. 5, the class margins m₀ and m₁ are determined asymmetrically by asymmetrically distributing the label margins mₐ.

As described above, according to the present example embodiment, even when learning of the classifier is performed using a data set in which the number of samples of classes is uneven, a classifier excellent in the separation performance between classes and the fairness of the separation between classes can be realized.

### Second Example Embodiment

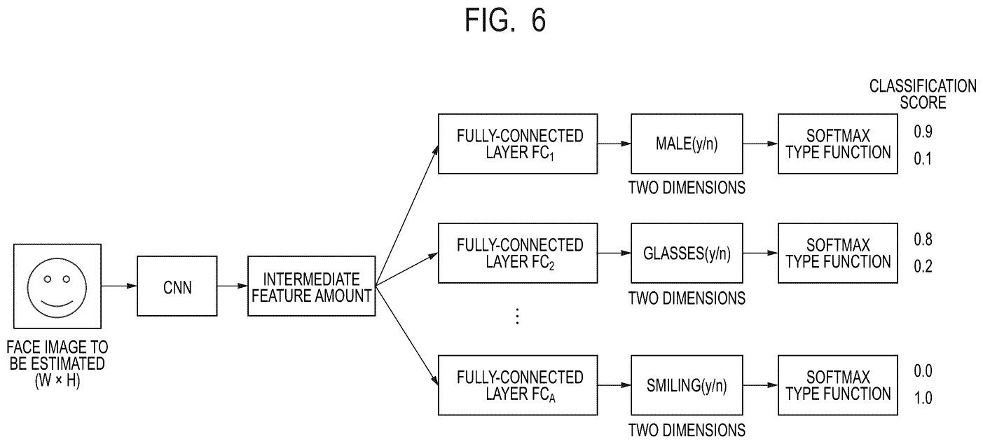

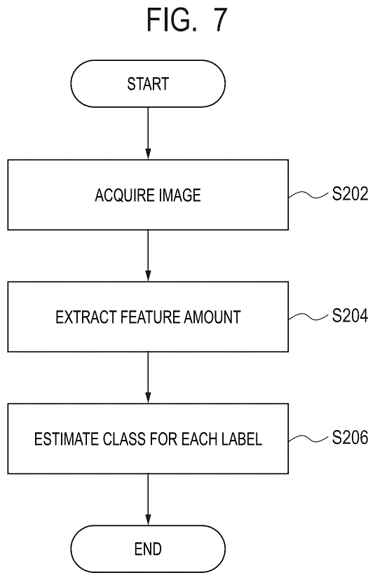

An information processing apparatus and an information processing method according to a second example embodiment of the present invention will be described with reference to FIG. 6 and FIG. 7. FIG. 6 is a schematic diagram illustrating an estimating method executed by the information processing apparatus according to the present example embodiment. FIG. 7 is a flowchart illustrating the estimating method executed by the information processing apparatus according to the present example embodiment.

In the present example embodiment, a case will be described in which the information processing apparatus 1 illustrated in FIG. 1 functions as an estimating apparatus that estimates and classifies classes of face images using the classifier model learned by the first example embodiment. The information processing apparatus 1 functioning as the learning apparatus and the information processing apparatus 1 functioning as the estimating apparatus may be the same or different from each other. The information processing apparatus 1 functioning as the estimating apparatus may not have the function as the learning apparatus.

The processor 10 functions as the image acquiring unit 102, the feature extracting unit 104, and the estimating unit 110 by executing a program stored in the storage 30 or an external program via the interface 60.

As illustrated in FIG. 6 and FIG. 7, the image acquiring unit 102 acquires a face image to be estimated (Step 202). The image acquiring unit 102 can acquire the face image to be estimated, which is previously stored in the storage 30, from the storage 30, or can acquire the face image to be estimated from an external device via the interface 60. The image acquiring unit 102 can also acquire the face image to be estimated by the input device 40 that is a capturing device.

Next, the feature extracting unit 104 extracts a feature amount of the face image to be estimated acquired by the image acquiring unit 102 in the same manner as in the first example embodiment (Step 204).

Next, the estimating estimates and classifies the classes of each label of the face image to be estimated by using the learned classifier model, which is learned by the information processing apparatus 1 according to the first example embodiment (Step 206). That is, the estimating unit 110 calculates the cosine similarity using the learned fully-connected layers FC₁ to FC_{A}. Next, the estimating unit 110 calculates the classification value of each class as a classification score from the cosine similarity using the Softmax type function as an output layer.

Thus, the information processing apparatus 1 estimates and classifies the classes of each label for the face image to be estimated.

### Third Example Embodiment

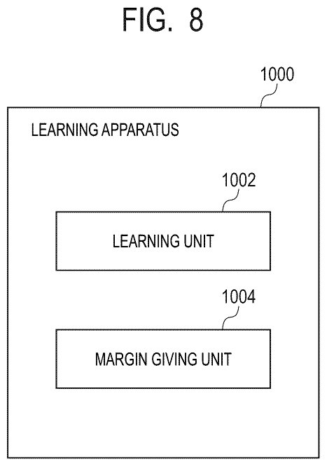

According to a third example embodiment, the learning apparatus which the information processing apparatus described in above example embodiment functions as may be configured as illustrated in FIG. 8. FIG. 8 is a block diagram illustrating a configuration of the learning apparatus according to the present example embodiment.

As illustrated in FIG. 8, the learning apparatus 1000 according to the present example embodiment is a learning apparatus that learns a classifier model that performs multi-class classification of single-label or multi-labels for images. The learning apparatus 1000 includes a learning unit 1002 that performs learning of the classifier model using a feature amount extracted from an image for learning as an input, and a margin giving unit 1004 that gives a margin to a loss function used for learning. The margin giving unit 1004 fixes a total amount of margin to be given for the single-label or the multi-label, and gives a class margin obtained by asymmetrically distributing the total amount of the margin to each of a plurality of classes of the single-label or the multi-labels.

In the learning apparatus 1000 according to the present example embodiment, a class margin is given, which is obtained by asymmetrically distributing the total amount of margin to a plurality of classes. Therefore, according to another example embodiment learning apparatus 1000, even when a classifier model is learned using a data set having uneven number of samples of classes, a classifier model excellent in the separation performance between classes and the fairness of the separation between classes can be realized.

### Modified Example Embodiments

The present invention is not limited to the example embodiments described above, and various modifications are possible.

For example, in the above example embodiments, the case of performing multi-label multi-class classification of face images has been described, but the present invention is not limited to this. The image to be subjected to multi-label multi-class classification may be an object image which is an image including one or more objects. In this case, multi-label multi-class classification can be performed on one or more objects recognized in the image.

In the above example embodiments, the case of learning the classifier model that performs multi-label multi-class classification has been described, but the present invention is not limited to this. The classifier model to be learned may perform multi-class classification of a single label, which is one label, on images such as face images.

In the above example embodiments, the case where Softmax type loss function is used as the loss function has been described, but the present invention is not limited thereto. Various functions can be selected as the loss function according to the object to be estimated and the like, and a margin can be given to the loss function in the same manner as described above. As the loss function, mean square error, mean absolute error or the like can be used in addition to Softmax type loss function and cross entropy error.

Further, the scope of each of the example embodiments includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a compact disc-read only memory (CD-ROM), a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary note 1)

A learning apparatus that learns a classifier model that performs multi-class classification of single-label or multi-labels for images, the learning apparatus comprising:
a learning unit that performs learning of the classifier model using a feature amount extracted from an image for learning as an input; and
a margin giving unit that gives a margin to a loss function used for learning,
wherein the margin giving unit fixes a total amount of margin to be given for the single-label or the multi-label, and gives a class margin obtained by asymmetrically distributing the total amount of the margin to each of a plurality of classes of the single-label or the multi-labels.
   (Supplementary note 2)

The learning apparatus according to supplementary note 1, wherein the classifier model performs multi-class classification for each of the multi-labels.

(Supplementary note 3)

The learning apparatus according to supplementary note 1 or 2, wherein the learning unit performs the learning of the classifier model by angular metric learning.

(Supplementary note 4)

The learning apparatus according to any one of supplementary notes 1 to 3, wherein the margin giving unit gives the class margin based on a proportion of samples of the class.

(Supplementary note 5)

The learning apparatus according to any one of supplementary notes 1 to 4, wherein the margin giving unit gives the class margin to the loss function, the class margin being calculated by the following Expression (1).

$$[ Math . 12 ]$$

$${m}_{a , c} ( {γ}_{a} ) = {α}_{a , c} ( {γ}_{a} ) \times {m}_{a} \qquad ( 1 )$$

(In Expression (1), mₐ is the total margin determined for the a-th label. α_{a,c} (γₐ) is calculated by the following Expression (2).

$$[ Math . 13 ]$$

$${α}_{a , c} ( {γ}_{a} ) = \frac{exp ( {γ}_{a} {sN}_{a , c} )}{{\sum }_{{c}^{″} ∈ C} exp ( {γ}_{a} {sN}_{a , {c}^{″}} )} \qquad ( 2 )$$

In Expression 2, N_{a,c} represents a proportion of the number of samples the c-th class in the a-th label. N_{a,c″} represents a proportion of the number of samples the c″-th class (c″ is an integer satisfying 1≤c″ ≤C) in the a-th label. The sum sign of the right-hand denominator in Expression (2) means the sum of all integers satisfying 1≤c″≤C. s is a hyperparameter.)

(Supplementary note 6)

The learning apparatus according to any one of supplementary notes 1 to 5, wherein the learning unit automatically determines at least one of the mₐ and the γₐ.

(Supplementary note 7)

The learning apparatus according to any one of supplementary notes 1 to 6, wherein the loss function is a loss function of Softmax type.

(Supplementary note 8)

The learning apparatus according to supplementary note 7, wherein the margin giving unit gives the class margin to be subtracted from cosine of an angle formed by a feature vector extracted from the image as a feature quantity and a representative vector of the class in the loss function of Softmax type.

(Supplementary note 9)

The learning apparatus according to supplementary note 7, wherein the margin giving unit gives the class margin to be added to an angle formed by a feature vector extracted from the image as the feature quantity and a representative vector of the class in the loss function of Softmax type.

(Supplementary note 10)

The learning apparatus according to supplementary note 7, wherein the margin giving unit gives the class margin to be multiplied to an angle formed by a feature vector extracted from the image as the feature quantity and a representative vector of the class in the loss function of Softmax type.

(Supplementary note 11)

The learning apparatus according to any one of supplementary notes 1 to 10, comprising a feature extracting unit that extracts the feature amount by convolutional neural network.

(Supplementary note 12)

The learning apparatus according to any one of supplementary notes 1 to 10, wherein the image is a face image.

(Supplementary note 13)

An estimating apparatus comprising:
an image acquiring unit that acquires an image;
an estimating unit that performs multi-class classification for the image by the classifier model learned by the learning apparatus according to any one of supplementary notes 1 to 12.
   (Supplementary note 14)

A learning method that learns a classifier model that performs multi-class classification of single-label or multi-labels for images, the learning method comprising:
performing learning of the classifier model using a feature amount extracted from an image for learning as an input; and
giving a margin to a loss function used for learning,
wherein giving the margin fixes a total amount of margin to be given for the single-label or the multi-label, and gives a class margin obtained by asymmetrically distributing the total amount of the margin to each of a plurality of classes of the single-label or the multi-labels.
   (Supplementary note 15)

A storage medium storing a program that causes a computer to perform: a learning method that learns a classifier model that performs multi-class classification of single-label or multi-labels for images, the learning method comprising:
performing learning of the classifier model using a feature amount extracted from an image for learning as an input; and
giving a margin to a loss function used for learning,
wherein giving the margin fixes a total amount of margin to be given for the single-label or the multi-label, and gives a class margin obtained by asymmetrically distributing the total amount of the margin to each of a plurality of classes of the single-label or the multi-labels.

Although the present invention has been described with reference to example embodiment, the present invention is not limited to example embodiment. The structure and details of the present invention may be changed in various ways that a person skilled in the art can understand within the scope of the present invention.

### REFERENCE SIGNS LIST

1 . . . information processing apparatus
10 . . . processor
20 . . . memory
30 . . . storage
40 . . . input device
50 . . . output device
60 . . . interface
70 . . . common bus
102 . . . image acquiring unit
104 . . . feature extracting unit
106 . . . classifier learning unit
108 . . . margin giving unit
110 . . . estimating unit
1000 . . . learning apparatus
1002 . . . learning unit
1004 . . . margin giving unit

What is claimed is:

1. A learning apparatus that learns a classifier model that performs multi-class classification of single-label or multi-labels for images, the learning apparatus comprising:
a memory configured to store instructions; and
a processor configured to execute the instructions to:
perform learning of the classifier model using a feature amount extracted from an image for learning as an input; and
give a margin to a loss function used for learning, wherein the processor is further configured to execute the instructions to fix a total amount of margin to be given for the single-label or the multi-label, and give a class margin obtained by asymmetrically distributing the total amount of the margin to each of a plurality of classes of the single-label or the multi-labels.

2. The learning apparatus according to claim 1, wherein the processor is further configured to execute the instructions to perform multi-class classification for each of the multi-labels.

3. The learning apparatus according to claim 1, wherein the learning processor is further configured to execute the instructions to perform the learning of the classifier model by angular metric learning.

4. The learning apparatus according to claim 1, wherein the processor is further configured to execute the instructions to give the class margin based on a proportion of samples of the class.

5. The learning apparatus according to claim 1, wherein the processor is further configured to execute the instructions to give the class margin to the loss function, the class margin being calculated by the following Expression (1).
$$[ Math . 1 ]$$
$${m}_{a , c} ( {γ}_{a} ) = {α}_{a , c} ( {γ}_{a} ) \times {m}_{a} \qquad ( 1 )$$
(In Expression (1), mₐ is the total margin determined for the a-th label. α_{a,c} (γₐ) is calculated by the following Expression (2).
$$[ Math . 2 ]$$
$${α}_{a , c} ( {γ}_{a} ) = \frac{exp ( {γ}_{a} {sN}_{a , c} )}{{\sum }_{{c}^{″} ∈ C} exp ( {γ}_{a} {sN}_{a , {c}^{″}} )} \qquad ( 2 )$$
In Expression 2, N_{a,c} represents a proportion of the number of samples the c-th class in the a-th label. N_{a,c″} represents a proportion of the number of samples the c″-th class (c″ is an integer satisfying 1≤c″≤C) in the a-th label. The sum sign of the right-hand denominator in Expression (2) means the sum of all integers satisfying 1≤c″≤C. s is a hyperparameter.)

6. The learning apparatus according to claim 1, wherein the processor is further configured to execute the instructions to automatically determine at least one of the mₐ and the ya.

7. The learning apparatus according to claim 1, wherein the loss function is a loss function of Softmax type.

8. The learning apparatus according to claim 7, wherein the processor is further configured to execute the instructions to give the class margin to be subtracted from cosine of an angle formed by a feature vector extracted from the image as a feature quantity and a representative vector of the class in the loss function of Softmax type.

9. The learning apparatus according to claim 7, wherein the processor is further configured to execute the instructions to give the class margin to be added to an angle formed by a feature vector extracted from the image as the feature quantity and a representative vector of the class in the loss function of Softmax type.

10. The learning apparatus according to claim 7, wherein the processor is further configured to execute the instructions to give the class margin to be multiplied to an angle formed by a feature vector extracted from the image as the feature quantity and a representative vector of the class in the loss function of Softmax type.

11. The learning apparatus according to claim 1, wherein the processor is further configured to extract the feature amount by convolutional neural network.

12. The learning apparatus according to claim 1, wherein the image is a face image.

13. An estimating apparatus comprising:
a memory configured to store instructions; and
a processor configured to execute the instructions to:
acquire an image;
perform multi-class classification for the image by the classifier model learned by the learning apparatus according to claim 1.

14. A learning method that learns a classifier model that performs multi-class classification of single-label or multi-labels for images, the learning method comprising:
performing learning of the classifier model using a feature amount extracted from an image for learning as an input; and
giving a margin to a loss function used for learning,
wherein giving the margin fixes a total amount of margin to be given for the single-label or the multi-label, and gives a class margin obtained by asymmetrically distributing the total amount of the margin to each of a plurality of classes of the single-label or the multi-labels.

15. A non-transitory storage medium storing a program that causes a computer to perform: a learning method that learns a classifier model that performs multi-class classification of single-label or multi-labels for images, the learning method comprising:
performing learning of the classifier model using a feature amount extracted from an image for learning as an input; and
giving a margin to a loss function used for learning,
wherein giving the margin fixes a total amount of margin to be given for the single-label or the multi-label, and gives a class margin obtained by asymmetrically distributing the total amount of the margin to each of a plurality of classes of the single-label or the multi-labels.
